(19) United States
(12) Patent Application Publication
(10) Pub. No.: US 2008/0051066 A1
(43) Pub. Date: Feb. 28, 2008

(54) DIGITAL PERSONAL ASSISTANT AND AUTOMATED RESPONSE SYSTEM

(75) Inventors: Jagadish Bandhole, Saratoga, CA (US); T.K. Lakshman, San Carlos, CA (US); Sekaran Nanja, San Jose, CA (US)

Correspondence Address: PILLSBURY WINTHROP SHAW PITTMAN LLP, P.O. BOX 10500, MCLEAN, VA, 22102, US

(73) Assignee: fonemine, Inc., Sunnyvale, CA (US)

(21) Appl. No.: 11/567,167

(22) Filed: Dec. 5, 2006

Related U.S. Application Data
(60) Provisional application No. 60/742,705, filed on Dec. 5, 2005.
(60) Provisional application No. 60/771,724, filed on Feb. 8, 2006.

(51) Int. Cl. H04M 11/10; H04M 3/42

(52) U.S. Cl. 455/413; 455/417

(57) ABSTRACT

Systems, apparatus and methods are described that provide abstractions, automation, personalization, tools and delivery systems useful in the publication, sharing, viewing, communication, transmission and reception of information on telephone networks. The invention provides systems, apparatus and methods for conducting transactions on telephone networks, for automated, customized, integrated and bimodal responses to phone calls. Subscribers may customize and configure personalized and customized automated response systems that are adaptable based on caller identity and time of day. Flexible customization of responses is enabled using rule-based engines. Personalized subscriber identities enable callers to reach subscribers without direct access to subscriber telephone numbers. Subscriber telephone numbers can be aggregated and accessed through a single contact point. Flexible automated call forwarding to appropriate subscriber telephone numbers is provided. The systems, methods and apparatus can be optimized for use in mobile devices and may be addressed using existing telephone numbers.

The present application claims priority from U.S. Provisional Patent Application No. 60/742,705, entitled “Digital Personal Assistant And Automated Response System,” filed Dec. 5, 2005 and which is incorporated herein by reference and for all purposes. The present application is also related to U.S. Non-Provisional patent application Ser. No. 11/555,673, entitled “Platform for Telephone-Optimized Data And Voice Services,” filed Nov. 1, 2006 and from U.S. Provisional Patent Application No. 60/771,724, entitled “Telephony Based Publishing, Search, Alerts And Notifications, Collaboration, And Commerce Methods,” filed Feb. 8, 2006, which applications are incorporated herein by reference and for all purposes.

### BACKGROUND OF THE INVENTION

1. Field of the Invention

The present invention relates to data communications and more particularly to voice integrated data communications in data access devices including telephones and computers.

2. Description of Related Art

Today's telephones often provide voice response systems that operate when a called subscriber does not pick up a call. This response is generally static in nature, must be created before a call is received, and remains unchanged in the absence of subscriber intervention. Voice responses are usually provided as a centralized service or through the use of physical devices such as answering machines. Today's telephone services also provide limited call forwarding capabilities, which are typically tied to the service itself and are generally difficult to program.

Automated response systems provide a very crude classification of the called subscriber state: namely busy or free. One set of actions (e.g. allow the telephone to ring) is used to respond when the called subscriber is free, while another set of actions (e.g. a canned voice response or call forwarding) is used to respond when the called subscriber is busy. Such crude classification compromises the richness of experience in favor of automation and is not only inadequate in comparison to a human personal assistant, but it is also frequently not practically feasible or scalable.

The above limitations are even more crippling when bimodal calls (i.e. voice or text) are to be handled and/or the automated responses are bi-modal (voice or text). For example, it is currently not possible to provide a called party with a brief text message without interrupting the called party, the message indicating changed circumstances such as new location of caller, caller is ready and so on. Thus there is a need for a flexible automated customizable response system for voice and text, as well as seamless transition from voice to text and back.

Businesses often spend significant resources managing telephones. An office administrator or a secretary often picks up calls and based on the caller identity and other caller characteristics, as well as the state of a called party. Other factors such as call volume select appropriate actions to be taken, including taking a message, re-routing the call to a specific telephone or a voice mailbox, providing custom responses, describing the reason the called party cannot take the call, and so on. Effectively, an office administrator function is provided for inbound and outbound communication. This manual, labor-intensive administrative function is typically rule driven where the input to the rules include called subscriber state, caller identity, time of call, caller location, caller priority, and external factors, whereas the output is one of many actions such as call re-routing, call blocking, call forwarding, or text operations such as taking a message or providing some text response. Not only is this function both manual and laborious, but there is generally no integration between voice and text available to office administrators and secretaries. Some office administrators use text based communication tools in addition to the telephone, including computers for sending and receiving email, for instant messaging, for scheduling and other calendaring activities and for keeping track of contacts. However, such tools are independent of telephone systems, and information is often duplicated, both on telephone systems and on office communication systems. Although some businesses may consider computer based office administration systems, these systems cannot be scaled for most individual consumer needs and are not accessible to traveling users.

Personal assistants can schedule and initiate calls at a specific time, but this is still a manual operation. There are currently no generic services which initiate a call at a specific time.

Furthermore, personal assistants are often not available outside predefined business hours and, even when available, can only handle a few calls in a given amount of time often resulting in limited quality of service and availability. It will be appreciated that personal assistants are unable to handle multiple calls simultaneously. Complex call center back office infrastructure is generally required to handle significant call volume and provide complex routing, call queues, and features such as on-hold music or information. It will be appreciated that costs associated with maintaining personal assistants place such service beyond the reach of most staff in a business, and the service is rarely implemented for general telephone subscribers.

Today's mobile devices provide a few additional personalization features, such as distinct ring-tones and distinct call-back tones which can be personalized based on caller identity. However, such features are limited to voice calls, and not applicable to data services such as SMS, GPRS/EDGE/3G. Finally, such features cannot be extended to enrich the caller experience via customization or personalization of the response.

Telephone systems do not provide any form of delivery confirmation, indicating that the call/message was delivered, or that it was picked up by the called subscriber.

Many telephone systems also do not provide a brokered notion of presence indicating whether or not the called subscriber is actually present and available for communication. Often, the only way to establish presence is if the called subscriber actually picks up the call.

An individual may have multiple telephone numbers, for example, one for work, one for mobile, one for home. Furthermore, many individuals may share a telephone number, for example, a home telephone number may be shared by everyone who lives at that home. Finally, multiple individuals may share a single telephone number but at different times or even concurrently (e.g., a phone bank). In each of these situations, it is impractical to seamlessly forward a call to one of many telephones or to provide personalized and automated voice/text responses.

### BRIEF SUMMARY OF THE INVENTION

Systems, apparatus and methods are provided that overcome problems associated with the development, deployment, and delivery of information services for data access devices such as telephone devices on telephone networks. A personal assistant and automated response system (hereinafter “PAARS”) is described in one embodiment as operating on a platform (hereinafter “Fonemine Platform”) that supports rapid development, deployment and delivery of a plurality of services including PAARS. Fonemine Platform is described in detail in related Provisional Patent Application No. 60/732,792, filed Nov. 1, 2005 and titled “Platform For Telephone-Optimized Data And Voice Services.” In certain embodiments, various telephone devices can be supported by Fonemine Platform, including mobile telephones, cell-phones, smart telephones, land-line telephones, gaming devices, computers and PDAs. In certain embodiments, PAARS receives calls directed to a called subscriber from any suitable telephone device and can automatically and programmatically provide responses in various combinations of text and voice formats.

In certain embodiments, PAARS provides flexible customization of responses based on rule-based engines that may be characterized as personal assistants. Such, rule-based engines operate on rules (hereinafter, “Fonerules”). Fonerules can be characterized by a condition-action pair wherein the action may be triggered when the condition is satisfied. Fonerules may be used to automate voice and text responses to received telephone calls. Personal assistants may be driven by a variety of factors including caller identity, caller location, time of call, status of the called subscriber, status of the called subscriber's telephone, call-characteristics, modalities such as voice and data and so on. Such factors can be embodied in the condition component of a Fonerule. Furthermore, personal assistants may take a variety of actions including forwarding an incoming call, dialing a specified telephone, returning a designated text or voice response and initiating sessions in which voice, text and other information can be exchanged between personal assistant and a caller. Fonerules within a PAARS system can enable subscribers to designate, personalize and automate responses to incoming calls from selected callers, in the manner that a human personal assistant can perform such functions. Fonerules specified by a subscriber may be evaluated by a PAARS rule engine to determine what response should be made to an incoming call. For example, response by voice, text, connecting or forwarding the call. PAARS can enable the called subscriber to publish content that may be viewed by a caller and both caller and called subscriber can exchange customized content, typically through established sessions, to enable effective communications even when the called subscriber is unavailable to receive the call. Fonemine Platform enables users such as ISVs, content owners and providers, telecom operators, messaging software vendors, and device manufacturers to rapidly create and deploy new voice integrated information services targeting consumers, business-consumers, advertisers and enterprises. PAARS can enable businesses and individual consumers to create their own automated personal assistant that performs effective call screening and provides suitable targeted response.

Embodiments of the present invention resolve issues in the prior art by enabling rapid service creation and delivery of content to and from data access devices such as telephone devices on a telephone network, through the use of Fonemine Platform. Certain embodiments provide data content and services that can be customized and optimized for telephone end-points, leveraging viewer and caller location. Fonemine created data services are typically bi-directional, active, multi-modal (identical mechanisms can be used to initiate voice calls and access to data), easy to navigate in comparison to voice navigation and can be integrated with traditional voice services. In many embodiments, navigation of data can be either text-menu-driven or voice-menu driven. Additionally, since telephone technology continues to be far more ubiquitous than internet end points, many embodiments include a content description, rendering and publishing language to overcome significant processing, memory and input/output issues associated with telephone keyboard and display, as well as navigational challenges associated with telephones and traditional voice networks. Further, in many embodiments, rich content can be rendered on supported telephone devices. For example, content can be dynamically translated from visual presentations of text and graphics to audio presentations of information extracted from the text and graphics.

Embodiments of the present invention provide a content abstraction called a Fonepage which provides basic data-structures used to publish, share, view, send and receive information and to accomplish transactions on telephone networks. Fonepage abstraction can be optimized for communication and viewing on mobile devices and may be addressed using existing telephone numbers. Further, Fonepage abstraction typically maintains a built-in location capability. Fonepage optimizations can be achieved using a plurality of tools including a new language (hereinafter “FONL”—Fone Optimized Network Language) for describing, rendering and publishing Fonepages on telephone devices, and a new protocol (hereinafter “FONP”—Fone Optimized Network Protocol) for data communications that enables telephone devices to rapidly communicate and share content with each other and with a central Fonemine service. In certain embodiments, FONL, FONP and Fonepages form the core components of a platform for rapid creation and delivery of information services targeting telephone devices. With the Fonemine platform, any telephone number can have an associated Fonepage which publishes useful information about the telephone number. A business Fonepage associated with a business telephone line can contain business specific content such as business hours of operation, services provided, pricing, promotions, etc. A personal Fonepage associated with a personal telephone number can contain personal information such as identifying information, preferences, contacts, interests and other such information selected for sharing with callers. A Fonepage associated with a telephone number may provide an ability to personalize, publish and disseminate information in response to a call made to the telephone number.

In many embodiments, an identical process can be used for calling a telephone number to initiate voice communication and for accessing a Fonepage associated with the target telephone number or user. The caller can either talk to the target user, reach the target user's voice mail or may additionally access the target's Fonepage. Accessing the target's Fonepage can result in the display of displayable Fonepage information on the caller telephone, or the presentation of audio by the caller telephone using a text to voice converter. Any user having a telephone number can publish their Fonepage, customize their Fonepage responses to calls based on caller characteristics, including location, time-of call, caller-identity etc., and can view other users' Fonepages simply by addressing their telephone number by means of a telephone that supports viewing Fonepages.

In many embodiments, subscribers can use a mnemonic text string (hereinafter “Foneword) as an easily remembered unique identifier that may be published and that can enable callers to reach a subscriber without having actual knowledge of the subscriber telephone number. For example, when a subscriber publishes a Foneword to a group of family, friends or colleagues, any caller from the group can subsequently use the subscriber's Foneword to establish communication with the subscriber. A Foneword typically provides a unique, addressable mnemonic that can conceal the subscriber's actual telephone number from the caller while enabling the caller to reach the subscriber via the PAARS system. The Foneword may also enable the subscriber to aggregate many different telephone numbers including, for example, work, home and mobile telephone numbers into a single unique Foneword which PAARS can subsequently dynamically resolve to a selected one of the telephone numbers based on information in a Fonerule. For example, if a caller tries to reach the subscriber via the subscriber's Foneword, the PAARS system can intercept the Foneword and resolve it to direct the call to a currently applicable subscriber telephone number. In addition, Fonerules can be evaluated by a PAARS rule engine to uniquely determine how to respond to incoming calls. Foneword and Fonerules can, together with the PAARS system, provide easily remembered, global, anonymous, and unique addressing capabilities that enable the subscriber to flexibly and automatically receive incoming calls at one of many telephones, including, for example, designated work, home or mobile telephone, and provide personalized response. Furthermore, Fonewords and the PAARS system can facilitate number portability and anonymity by enabling subscribers to change telephone numbers without the burden of publishing their new telephone number to all of their contacts. Additionally, PAARS and Fonerules coupled with Fonewords can provide subscribers with the ability to limit access to callers for specific time durations. While access is limited, automated personalized responses can be provided so certain callers receive a relevant response.

Fonewords in conjunction with Fonerules, can also provide indirection and shortcut capabilities that enable the subscriber to route the caller directly to one of many subscriber Fonesite resources such as fonepages, ring tones and images.

Fonewords, in conjunction with Fonerules can also provide voice integrated passive calling capabilities which enable a caller to leave structured voice or text messages in the form of fonepages with a PAARS/Fonemine enabled service without interrupting the subscriber. A caller can leave a notification for a subscriber which the subscriber can pick up when connected at some later time. The PAARS service can act as an intermediary service between caller and subscriber that takes messages in a manner similar to a human administrative assistant for delivery at a time selected to the subscriber.

The foregoing and other aspects of various embodiments of the present invention will be apparent through examination of the following detailed description thereof in conjunction with the accompanying drawings.

### BRIEF DESCRIPTION OF THE DRAWINGS

The present invention is illustrated by way of example, and not limitation, in the figures of the accompanying drawings in which like references denote similar elements, and in which:

FIG. 1 depicts a prior art human-based personal assistant

FIG. 2 illustrates a conceptual system diagram of an embodiment of the invention;

FIG. 3a depicts an example of a typical Fonemine platform;

FIG. 3b depicts an example of a PAARS enabled Fonemine system;

FIG. 3c depicts an example of system configuration in a PAARS enabled Fonemine system;

FIG. 4 depicts an example of an embodiment of the invention implemented on a Fonemine platform;

FIG. 5 is an architectural drawing showing one implementation of a network in one embodiment of the invention;

FIG. 6 provides examples of call processing in a PAARS system;

FIG. 7 illustrates functional elements of PAARS enabled Fonemine system; and

FIG. 8 is a flowchart illustrating Fonerule function.

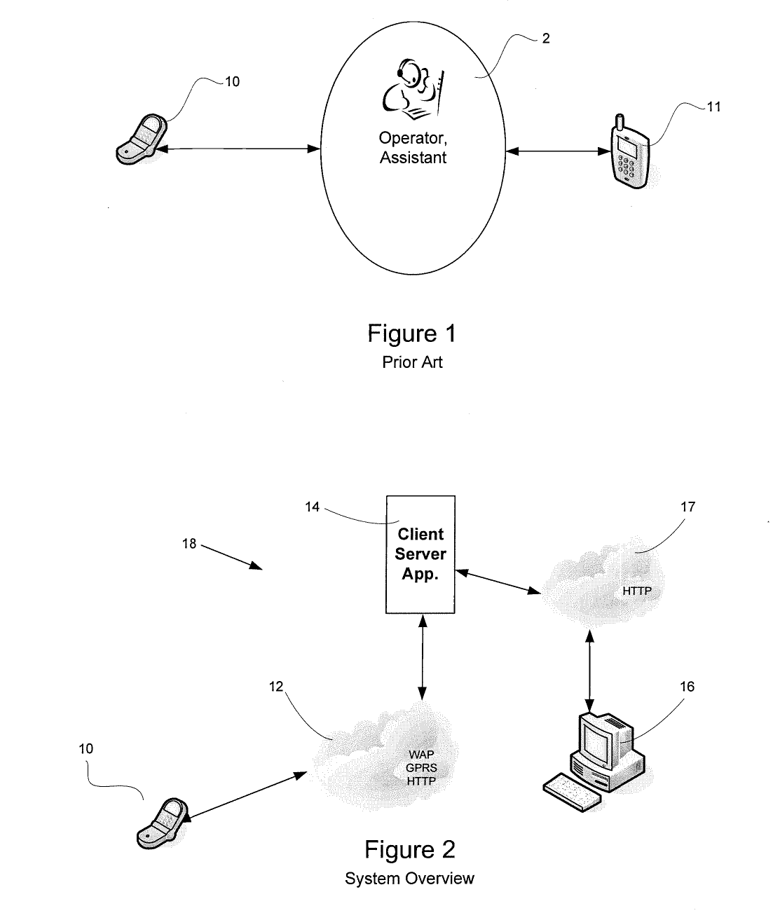

### DETAILED DESCRIPTION OF THE INVENTION

Embodiments of the present invention will now be described in detail with reference to the drawings, which are provided as illustrative examples so as to enable those skilled in the art to practice the invention. Notably, the figures and examples below are not meant to limit the scope of the present invention. In the drawings, like components, services, applications, and steps are designated by like reference numerals throughout the various figures. Where certain elements of these embodiments can be partially or fully implemented using known components, only those portions of such known components that are necessary for an understanding of the present invention will be described, and detailed descriptions of other portions of such known components will be omitted so as not to obscure the invention. Further, the present invention encompasses present and future known equivalents to the components referred to herein by way of illustration.

Embodiments of the present invention provide systems and methods for providing response to incoming telephone calls that is flexible, customizable and programmable. In certain embodiments responses can be customized based on caller identity and other characteristics such as caller location, time call was received, caller telephone number. Characteristics associated with responses may be configured remotely. Further responses can provide the caller with alternative actions to take depending on the actual response

In certain embodiments, telephone services provide a plurality of call forwarding capabilities configured to forward calls based on telephone service provider information, subscriber information, caller information and persons, business or group of persons targeted by the call. Call forwarding capabilities may be customized locally or remotely based on caller identity or other caller characteristics as well as the time the call was placed.

In certain embodiments automated response systems are provided that include features and services such as classification of called subscriber state (e.g. busy, free, etc.). A set of rules can be defined that direct actions based in part on called subscriber availability and other state information. Typically, potential actions include continuous ring, direct to voice response system, forward call, establish multimedia connection, establish text connection, and so on.

In certain embodiments, bimodal voice and text communications are supported. Typically, bimodal communications enable mixed-mode response systems and seamless transition from voice to text and back.

In certain embodiments, a personal digital assistant is provided that manages telephone interactions. In some embodiments, the personal digital assistant can receive calls and react to information provided during call establishment including caller identity, initiating service provider and other caller characteristics. In some embodiments, the personal digital assistant may also access other sources of information including call volume, called subscriber availability, time of day, caller priority, and external factors and other calendar information, location of caller and so on. The personal digital assistant may be configured to initiate one or more actions in response to the incoming call, including recording voice or text messages, blocking calls, redirecting the call to a specific telephone or a voice mailbox, providing responses customized to combinations of factors, providing status information to a called subscriber that may include reasons for redirection or non-responsiveness.

In certain embodiments, a personal digital assistant can schedule calls and can initiate calls at a scheduled time. In one example, the personal digital assistant can monitor subscriber schedules and initiate or join conference calls at appointed times. In the latter example, the personal digital assistant can notify or establish a connection to subscribers upon confirmed conference call establishment. Typically personal digital assistants can monitor multiple lines associated with a user and can dynamically reprioritize and reschedule calls and events dynamically and in parallel.

Further, in certain embodiments, advanced personalization features can be added with ease. For example, distinct ring-tones and distinct call-back tones which can be personalized based on caller identity. These advanced personalization features can be applied to data services (e.g. SMS, GPRS/EDGE/3G, etc.).

In certain embodiments, delivery confirmation can be provided that indicates delivery, receipt and acknowledgement of a voice or text message. In some embodiments, a brokered notion of presence is provided that can indicate whether or not the person being called is actually present and available for communication.

In certain embodiments, calls can be directed and redirected to groups of telephone numbers on which an individual can receive calls. Such grouping can be overlapping, dynamically modifiable, and associated with an easily recalled identifier. Group identifiers can be published to one or more subscribers. In some embodiments, published group identifiers may be accessible to other members of the group but, in at least some embodiments, group membership may be wholly or partially concealed. Various forms of partial concealment can be provided, including the withholding of all information concerning selected members and the withholding of certain types of information associated with members the type of information including, for example, individual telephone numbers, Email addresses and street addresses. Group identifiers may be published globally and identifiers can optionally be centrally assigned to permit the provision globally unique identifiers.

In certain embodiments, Fonewords in conjunction with Fonerules, can provide indirection and shortcut capabilities that enable the subscriber to route callers directly to one of many Fonesite resources such as fonepages, ring tones and images. For instance, a specific foneword FW1 can direct a caller directly to a specific image I1 which is a part of a subscriber's fonesite resources, whereas another foneword FW2 can direct the same caller directly to a different specific image I2, also from the subscriber's fonesite resources.

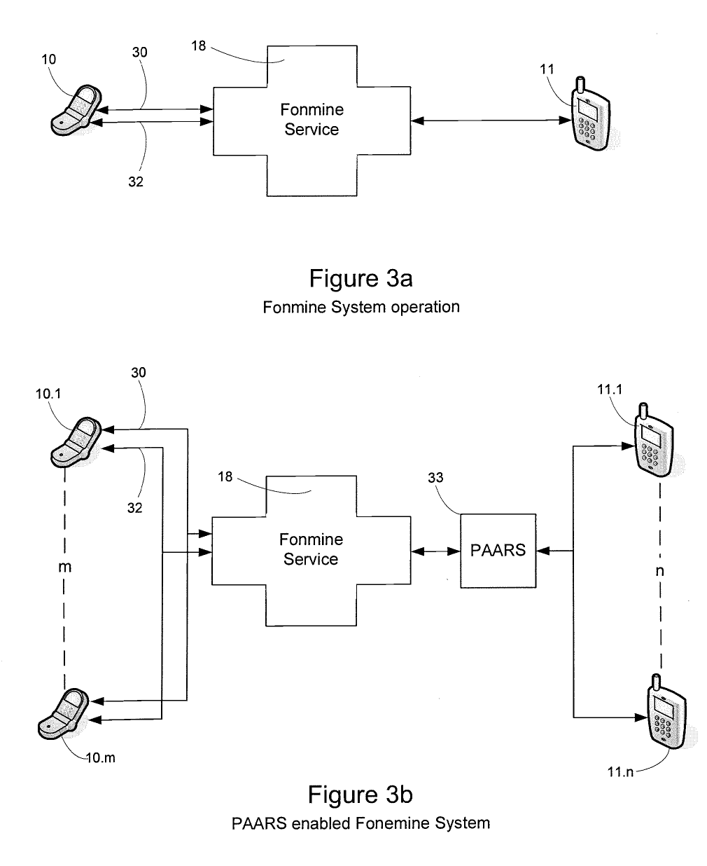

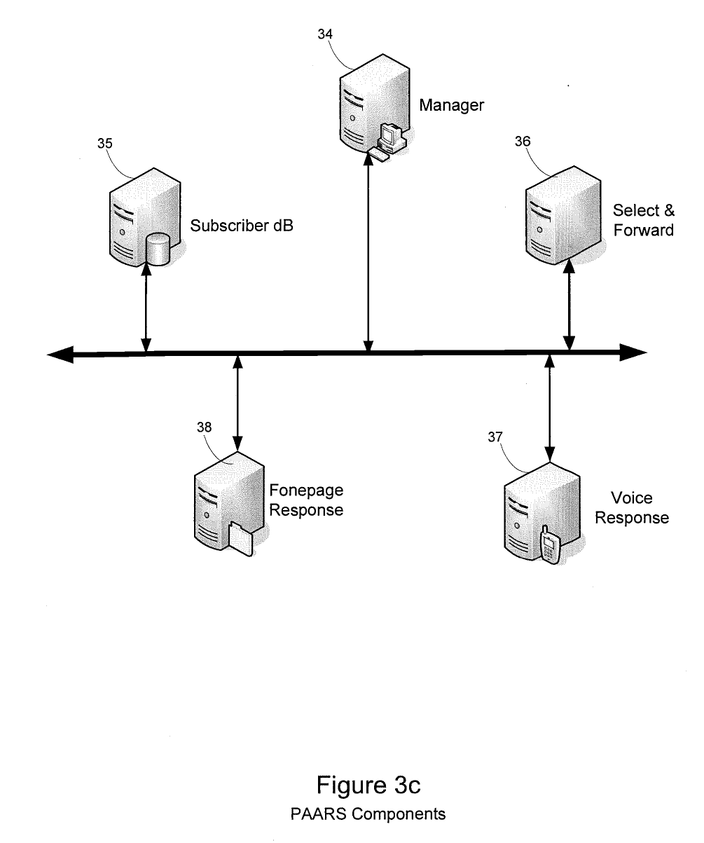

FIGS. 3a, 3b and 3c depict examples of implementations of a Fonemine System and a PAARS enabled Fonemine System. In FIG. 3a, caller 10 attempts to connect to called subscriber 11. Typically, the call is initiated using a voice connection 30. Fonemine Service provider 18 employs a Fonemine System configured to handle the incoming call by establishing a voice call with called subscriber 11 and maintaining voice connection 30, responding with a data or text connection 32 to provide non-verbal information to caller 10 or some combination of both voice 30 and text 32 connections. Additional options may include redirecting the call to called subscriber 11 at a designated telephone number and redirecting the call to a third party identified by Fonemine Service 18.

Referring now to FIGS. 3b and 3c, in certain embodiments a PAARS system 33 is implemented by Fonemine service provider 18. PAARS system 33 typically includes management system 34, subscriber database 35 selection and forwarding engine 36, bi-modal communication providing voice response 37 and Fonepage response 38. It will be appreciated that, although components of PAARS system 33 are depicted on individual devices, it is contemplated that each component may be distributed over a plurality of devices and, in some embodiments, some or all of the components may be implemented on a single server.

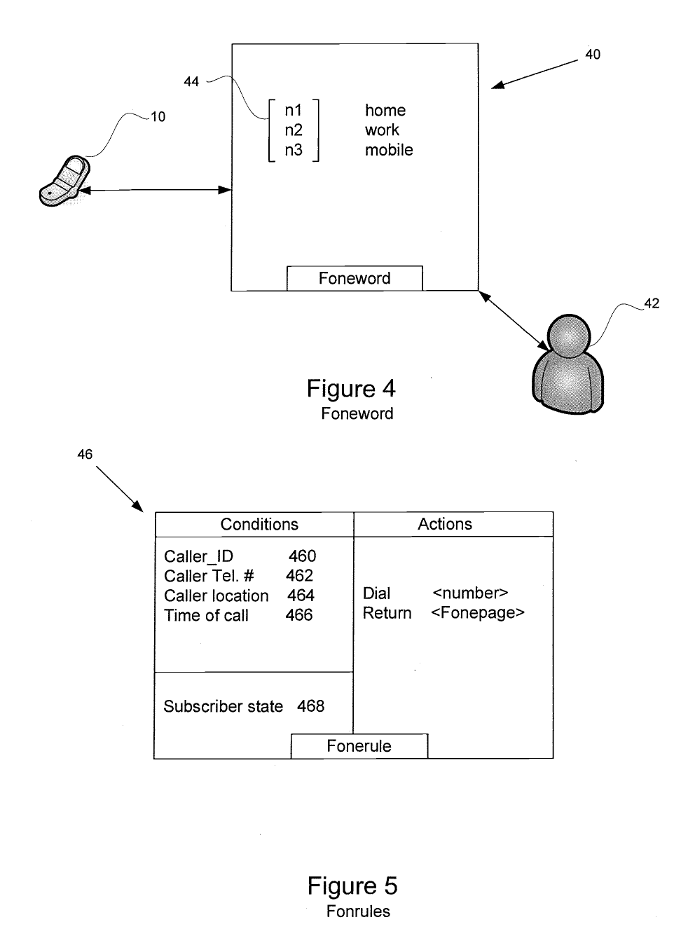

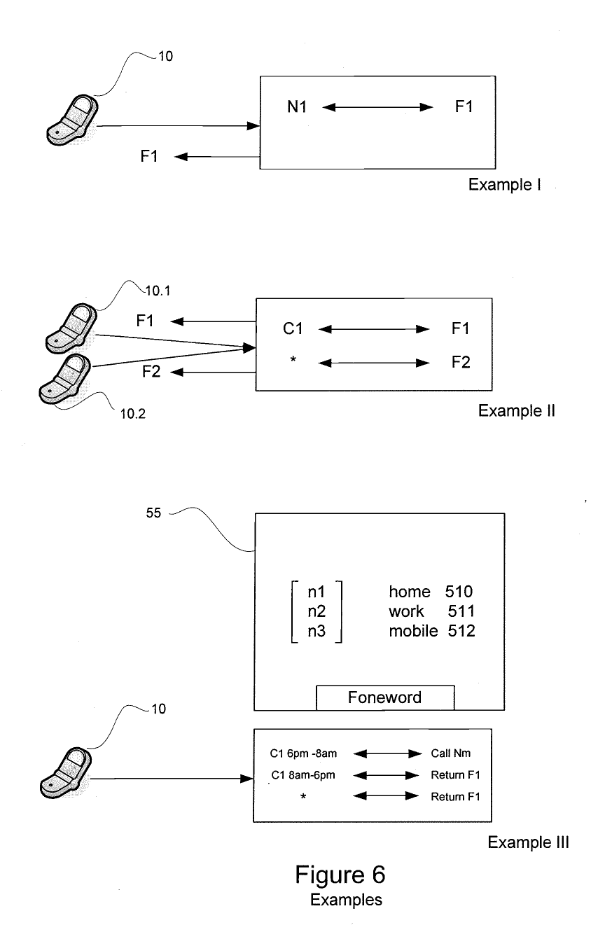

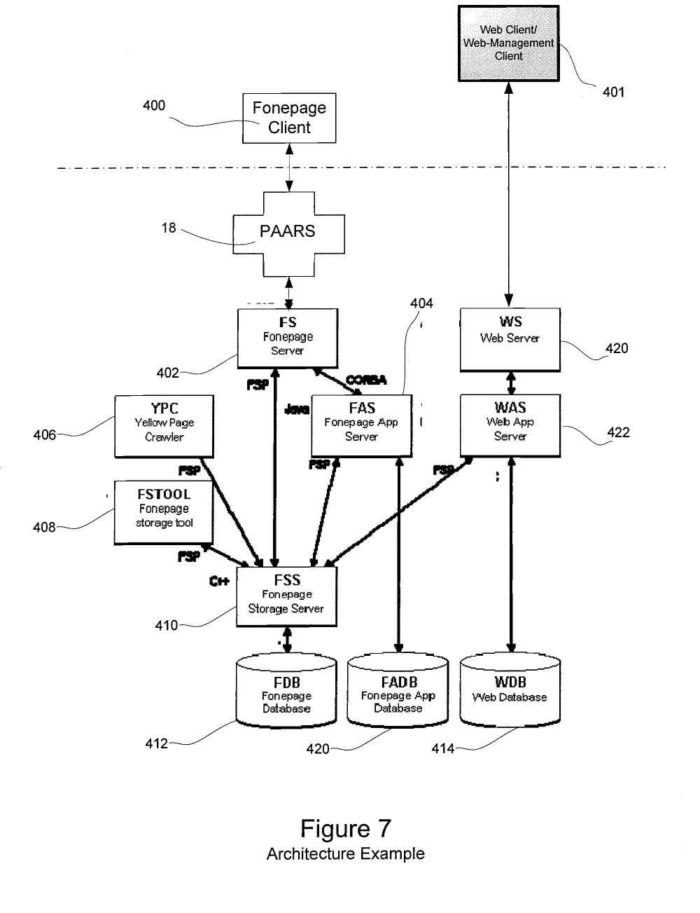

Referring now also to FIGS. 4-6, in some embodiments, a globally unique alphanumeric string (“Foneword”) 40 identifies and associates an individual 42 with a group of telephone numbers 44 and rules (“Fonerules”) 46 that map callers 10 to called subscribers 11. Fonerules 46 include inputs based on caller identity 460, caller telephone number 462, caller location 464, external factors such as time of call receipt 466, and state of the called subscriber 468. Fonerules 46 may initiate actions that can include returning a specific Fonepage for the caller and forwarding a call to another telephone number.

In one example, a grammar for Fonerule is defined as follows:

Fonerule::<Condition>→<Action>

### This rule specifies that for any incoming call, if <Condition> is met then execute <Action>

<Condition> ::
<caller> <location> <time-range>

### The condition typically consists of caller identity, caller location, and the time-range (start-time to end-time) in which the condition is applicable.

<caller>::<contact>|Group+|“ALL”

### The caller can be a specific contact in the called subscriber's contact list, the caller can belong to a group of contacts (e.g., Friends, or Family). Rule applies to ANY CALL.

<location>::[country-code][area-code]|Location-info (Lat/Long)

### The location typically specifies a geographic location associated with the caller that may be a crude static directive such as the caller country or the caller area-code, and can also be a finer grained dynamic directive such as caller's current location.

<time-range>::(time, time)

The first time component specifies the “start time” and the second time component specifies the “end time”. The duration thus specified between the start time and the end time is the period of validity of the rule. This period could be recurring with a recurrence frequency specified.

time :: [date|month] [day] [hour] [minute]
Action::
dial: <FQFN-URL> | <FURL>

An action is undertaken in response to a condition either to dial a number selected by the caller or a number selected by the called subscriber for forwarding. Additionally, the action can be a response by Fonepage, which Fonepage can result in further actions initiated by the caller.

The PAARS system typically includes a rule engine for processing Fonerules. In certain embodiments, any call can be initiated by specifying a telephone number to be called or by specifying a Foneword. In either case, Fonerules can determine what action is required in handling the call. Hence, Fonerules can be associated with either a called telephone number or a called Foneword.

In one example, a subscriber publishes a Fonepage (F1) 50 for their telephone number (N1) 51. Subsequently, all callers 10 who call N1 51 can optionally receive Fonepage 50 in response to the call. Typically, a caller 10 will receive Fonepage 50 at the discretion of the called subscriber 11. In some embodiments, Fonepage 50 can be provided automatically when the called subscriber's telephone is busy, the called subscriber is busy, not present or otherwise unable to receive the call. It will be appreciated that Fonepages can advantageously provide feedback to a caller even when the called subscriber is unavailable. Such feedback can result in further communication between the caller and called subscriber using combinations of data (e.g. Fonepage) and voice. For example, Fonepage F1 can be presented that contains an alternative number to call. In some embodiments, calls can be directly forwarded to a telephone number designated by the called subscriber.

In another example, a subscriber publishes two Fonepages (F1, F2) 500 and 501 for their telephone number (N1) 51. The subscriber can create a fonerule 52 that provides a caller 10 with F1 500 but provides all other callers F2 501. In this case, caller C1 56 can receive personalized fonepage F1 500 in response to calling N1 51, whereas all other callers receive F2 501. Furthermore, a called subscriber 11 may choose to prevent interruption by incoming calls.

In another example, a subscriber can set up a foneword 55 with three telephone numbers (Nw 510, Nh 511, and Nm 512, for work, home, and mobile telephones, respectively. The subscriber may then augment a personal fonerule 52 to take different actions depending on whether the caller is C1 56 or someone else, and whether or not the call occurs during work hours (8 am to 6 pm). In the example, if the time lies between 8 am and 6 pm and the caller is identified as C1 56, then Fonepage F1 500 can be returned. Additionally, in the example, all other callers may receive Fonepage F2 501. In this example, the rule can forward all calls from C1 56 during business hours. 8 am-6 pm to the called subscriber's fonepage F1 500, whereas all calls from C1 56 between 6 pm and 8 am may be redirected to the called subscriber's mobile telephone (Nm). If the call is from someone other than C1 then this call may never be picked up and instead Fonepage F2 502 is returned.

A subscriber can create a fonerule which directs all calls from callers associated with a selected location to fonepage F1 500, whereas for all other callers response is F2 501.

(No Foneword): Caller C1, N1, L1 “calls” called subscriber C2, N2 at time T.

Input: FONE-NUMBER N2, N1, L1, T

Find a rule that matches <N1, L1, T>

If such a rule exists, take the “action” corresponding to the rule. This action could be either “Return a fonepage” or “Call N2

If no such rule exists, “connect the call to N2”

Output: Either “action” OR “connect call”

Foneword Engine: (Rule Engine+Foneword): Caller C1, N1, L1 calls called subscriber C2 at time T.

Input: Foneword W, N1, L1, T, C2

MAP Foneword to N2.

Find a rule in N2's rule-engine that matches <N1, L1, T>

If such a rule exists, take the “action” corresponding to the rule. This action could be either “Return a fonepage” or “Call N2

If no such rule exists, “connect the call to N2”

Output: Either “action” OR “connect call”

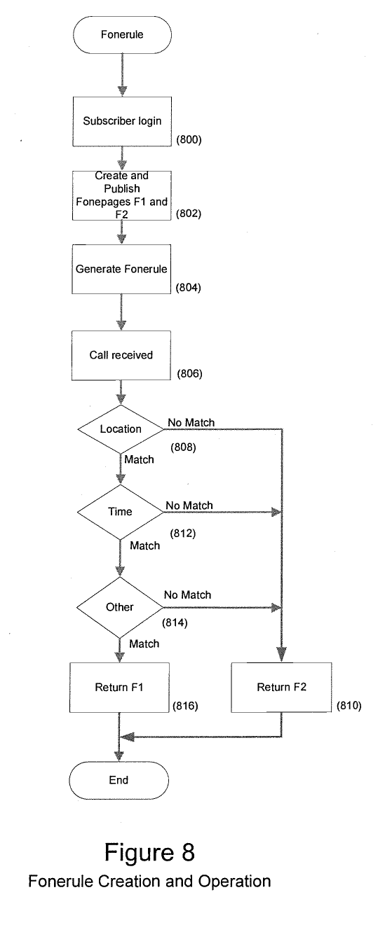

Referring now to FIG. 8, the operation of a Fonerule may be better understood. Fonerules may be dynamic in nature and can typically be created and deleted by a subscriber. To modify, delete or create a Fonerule, a subscriber can be required to provide authentication of identity or authorization to modify Fonerules for a subscriber account. In one example, a subscriber is required to provide user identification and password at step 800. Next, subscriber creates and publishes one or more Fonepages at step 802. At step 803, subscriber can define conditions and actions related to published Fonepages at step 803. For example, subscriber may provide time, location and identity of callers as conditions that must be met before a selected Fonepage is delivered.

At step 806, subsequent to Fonepage publication and Fonerule creation, a call is received from caller 10. At step 808, a first condition is tested. In the example of FIG. 8, the first condition is set as a location identifier but it can be appreciated that order of condition testing is configurable during Fonerule set up in many embodiments. Location information can relate to geographic location of caller 10, caller's 10 area code, and can be related to geographic location of called subscriber 11. Location condition may also be restrictive such that a match occurs if caller 10 is not associated with a geographic location. If caller 10 does not meet the location conditions, Fonepage F2 may be presented at step 810. It will be appreciated that multiple levels of conditions can be configured such that multiple levels of testing can be performed for each result of a prior test.

At step 812, time condition is tested where the user meets the location condition requirements. Typically, time is related to time of day but can also include day of week, month and year, etc. If caller 10 fails to match the time condition, then Fonepage F2 is presented at step 810. If time condition is met, then, at step 814 other conditions are tested. The other conditions can be temporary in nature, including a subscriber selected make busy status, a subscriber telephone being busy or otherwise unavailable and call refusal based on information presented to a called subscriber 11.

If a match to the other condition category is detected, then Fonepage F1 may be presented at 816; otherwise Fonepage F2 may be presented at step 810. Fonerules may have simple and complex condition tests. Multiple conditions may be tested to determine specific combinations of conditions that may initiate an action. Additionally, condition testing may be recursive, with certain failures influencing decision making on subsequent passes.

Examples of condition combinations include:

If caller N1, return fonepage F1, else return fonepage F2.

If caller N1 calls between 3 pm and 7 pm, return fonepage F1, and if N1 calls at any other time return F2, and for all other callers return fonepage F3.

If caller N1 calls, establish voice connection, else fonepage F1

All calls forwarded to designated number N2, except for caller N1, establish voice connection.

Many embodiments include a logging system that, for each invocation of a rule, a log records input parameters, current conditions and action taken. The logging system can provide call history and notification functions that the called subscriber can always obtain from their Fonesite.

Embodiments of the invention are provided as enhanced or additional services in telephone networks. In certain embodiments, systems described above provide services in cooperation with a Fonemine platform, which is described in related provisional application Ser. No. 60/732,792, filed Nov. 1, 2005 and titled “Platform For Telephone-Optimized Data And Voice Services.” Certain aspects of the Fonemine platform are described below.

In certain embodiments, Fonemine systems enable the provision of enhanced services on communications devices including, for example, cellular telephones, personal data assistants, conventional telephones (public switched telephone network “PSTN”), tablet and mobile computers, and so on. In many embodiments, the communications devices have limited user interface capability. In certain embodiments, displayable data can be provided in response to a telephone call to a subscriber of the system such that a calling device may display text and graphics data formatted for the calling device and related to the subscriber. In certain embodiments, the displayed data is pre-converted to voice using a text to voice translation and presented to the calling device as a voice response. The telephone call is typically initiated by dialing a subscriber telephone number or by entering a Foneword that can be mapped by PAARS to a unique valid telephone number. The data may include information of general interest such as contact information, availability information and links to further information, typically organized by category, keyword, subject, and so on. Where the subscriber is a business, the information may include commercial messages, details of products and services, marketing, contact, location and other such information. In many embodiments, the caller may initiate one or more actions by selecting from various options presented in the data. These actions can include options to browse, search, navigate, save, input message or other text information, retrieve coupons and redirect to other subscribers. In certain embodiments, these actions can be voice driven.

Further, in certain embodiments, a caller may establish a telephonic voice connection call by selecting an option provided in the information. Calls may be established with a communications device associated with the subscriber telephone number dialed by the caller. Optionally, a selectable call option may cause a telephonic connection to be established between the caller and a communications device designated by the subscriber. Thus, for example, a call can be redirected from a cellular telephone to a designated land-line telephone. Further, certain embodiments enable the establishment of integrated text and voice connections between the caller and the subscriber. As will be described in more detail below, content of the information can be highly customized and customized information can be further reconfigured automatically based on factors including location of subscriber, location of caller, a selected other location, identity of caller, access rights of caller and time of day and other calendar-based information.

Embodiments of the invention provide an interface that enables users of the mobile devices to access networked services including personalized applications, personal data, and shared information. For the purpose of this discussion, servers, tools and network protocols configured for the provision of the disclosed services will be referred to as “Fonemine Platform.” In certain embodiments, Fonemine Platform abstracts low-level protocol specific operations and device-specific functions from application software and users. This abstraction can enable the provision of a set of core services to subscribers by mapping the core services to generalized high level control commands and services. These high level commands and services can be invoked using applications that perform any desired function including publishing, search, inventory management, scheduling, reservations, personal information manager (PIM), event management, invitations (Evites), and other collaborative functions including, for example, m-commerce, where mobile devices can be used for transactional operations including purchases from vending machines, reservations such as parking space, and modifying existing reservations. Each such service can typically be augmented by PAARS to provide flexible customized programmable and automated responses to specific calls and callers and to initiate subsequent follow-up communications.

In certain embodiments Fonemine Platform enables integration and invocation of existing applications and provides a framework for developing new applications and services using a set of APIs. Fonemine Platform typically implements all low level functionality needed to publish desired content, view or hear desired content, or to build any mobile application or service.

In certain embodiments, Fonemine platform enables presentation of content as an abstracted and structured component (hereinafter referred to as Fonepage). Fonepages can be presented on any supported mobile device in a form adapted to the capabilities of the mobile device. In one example, a Fonepage is formed as a structured page that may be uniquely associated with a telephone number. In certain embodiments, Fonepages are optimized for the limited capabilities of a mobile device and may be further optimized for access using voice networks. In certain embodiments, Fonepages are location aware and content may be altered based on geographical information related to the mobile device.

In certain embodiments, Fonepages comprise combinations of information types including, for example, personal data and preferences and information repositories such as telephone contacts, content favorites, calendar, events, meetings, pictures, ring tones, applications, games, and coupons. In one example, Fonepage content may be provided based on predetermined access-control rules that determine access rights afforded to users and mobile devices. These access control rules may be configured by owners of content, service providers, and may be limited based on temporal and geographic factors.

In certain embodiments, the Fonemine Platform can provides producers or creators with an ability to create, update and organize collections of Fonepages, while enabling viewers to view Fonepages on their mobile devices. Fonepages can be business Fonepages, capturing business content or personal Fonepages capturing personal content. In certain embodiments, Fonepages may be created with substantially different format and functionality from web-pages created for viewing on a conventional browser and web-pages delivered to mobile devices via protocols such as HTTP, SMS and WAP. Fonepages can be optimized to overcome mobile device presentation limitations such as display and data input limitations, as well as navigation limitations, and can be further optimized to maximize communication capabilities using limited function protocols such as SMS which has a relatively small maximum message size and is supported by most of the mobile devices. Furthermore, Fonepages can be optimized for delivery to mobile devices configured to use protocols such as GPRS/EDGE and CDMA 1X and CDMA EVDO, for providing high bandwidth data access. Thus, it will be appreciated that Fonepages capture certain benefits of available underlying protocols while providing some unique advantages.

In certain embodiments, the interface provides voice and data integration services to the mobile device. Such integration includes the ability to specify commands to the Fonemine server via voice, the ability to receive data in the form of voice, and the ability to seamlessly go back and forth from data-access to voice-calls.

Certain embodiments support automatic response systems that direct callers through a menu tree to desired information or contacts. Conventional systems are generally based on voice and tone dialing capabilities of a telephone and are necessarily linear in nature. In contrast, Fonemine-enabled systems can provide multimedia menus. Upon recognizing a Fonemine enabled user device, a response system may provide a complete menu structure in the form of a Fonepage. In some embodiments, a localized menu structure is provided based on location of the user device, home or business address information of the user where available to the response system or based on specific geographic information received from the user or system administrator. Additionally, in many embodiments, a user may receive a menu structure configured and transmitted by a third party, such as a customer support representative, a website or conventional voice response system.

In many embodiments, Fonemine enabled response systems operate using Foneword—a keyword/mnemonic based number entry subsystem—in which a caller can enter a Foneword to access a desired customer service number (e.g. 1-800 number) or to a predetermined direct dial number. By combining profile information associated with a user, geographic information associated with desired services, account information and positional information, rapid navigation of a menu tree can be achieved through the elimination of multiple steps in menu trees. Additionally, menus presented to a Fonemine user device can be in text or graphics form, allowing a user to make a desired selection quickly and accurately. Further, location-specific information permits rapid access to local services.

In certain embodiments, pre-defined forms can be created by users that can be provided to response systems for customizing menu structures and facilitating accurate responses. The pre-defined forms can include information that includes customer support, field access, pre-sales, financial service, information services, etc.

In certain embodiments, anonymous pages and vanity pages are provided that may be based on Foneword. For example, new Fonepages can be generated and linked to existing pages, or provided as top level, universally-addressable Fonepages.

It is apparent that the above embodiments may be altered in many ways without departing from the scope of the invention. Further, the invention may be expressed in various aspects of a particular embodiment without regard to other aspects of the same embodiment. Still further, various aspects of different embodiments can be combined together. Accordingly, the scope of the invention should be determined by the following claims and their legal equivalents.

What is claimed is:

1. A method comprising:
receiving from a caller, a call directed to a subscriber in a telephone network;
optionally providing an automated response to the caller, wherein the automated response is selected from one or more responses configured by the subscriber; and
selectively forwarding the call to designated telephone, wherein the call is forwarded based on one or more conditions including time of day, identity of caller, subscriber status and predetermined rules configured by the subscriber.

2. The method of claim 1, wherein the selectively forwarding step includes the steps of:
receiving one or more rules associated with the subscriber, each rule comprising conditions and actions;
identifying characteristics of the call satisfying at least one of the conditions; and
executing an action associated with the satisfied at least one condition, wherein the action includes forwarding the call and returning a text message.

3. The method of claim 2, wherein the one or more conditions include time of day and identity of the caller.

4. The method of claim 1, wherein the providing step includes the steps of:
receiving one or more rules associated with the subscriber, each rule comprising conditions and actions;
identifying characteristics of the call satisfying at least one of the conditions; and
executing an action associated with the satisfied at least one condition, wherein the action includes providing the automated response.

5. The method of claim 4, wherein the selectively forwarding step includes the steps of:
receiving one or more rules associated with the subscriber, each rule comprising conditions and actions;
identifying characteristics of the call satisfying at least one of the conditions; and
executing an action associated with the satisfied at least one condition, wherein the action includes forwarding the call, returning a fonepage and returning a text message.

6. The method of claim 4, wherein the one or more conditions include time of day, caller location and identity of the caller.

7. The method of claim 1, wherein the one or more responses includes text and voice responses.

8. The method of claim 1, wherein the one or more responses includes indirections for routing the call to selected published information including fonepages, ring tones and images.

9. The method of claim 1, wherein the designated telephone is identified by one or more telephone numbers associated with the subscriber.

10. A method comprising
publishing a unique identifier for a subscriber;
associating the unique identifier with a plurality of destinations associated with the subscriber; and
establishing a plurality of rules for selecting actions based on predetermined conditions, wherein the actions include forwarding an incoming telephone call to a selected one of the plurality of destinations, and wherein the plurality of destinations include at least one telephone number and one or more displayable messages.

11. The method of claim 10, wherein the predetermined conditions include time periods, identity of caller and location of subscriber.

12. The method of claim 10, wherein the actions include transmitting one of the displayable messages to the subscriber.

13. The method of claim 10, wherein the actions include transmitting one of the displayable messages to the caller.

14. The method of claim 13, wherein the one displayable message indicates availability of the subscriber.

15. The method of claim 10 wherein the one displayable message indicates receipt of the call.

16. The method of claim 10, wherein the actions include scheduling of calls and responses to calls.

17. The method of claim 10 wherein the plurality of rules can be configured by the subscriber.
